(19) United States
(12) Patent Application Publication
(10) Pub. No.: US 2025/0113393 A1
(43) Pub. Date: Apr. 3, 2025

(54) RECONFIGURATION SIGNALING FOR SEAMLESS ROAMING

(71) Applicant: QUALCOMM Incorporated, San Diego, CA (US)

(72) Inventors: Abhishek Pramod PATIL, San Diego, CA (US); Gaurang NAIK, San Diego, CA (US); Sai Yiu Duncan HO, San Diego, CA (US); George CHERIAN, San Diego, CA (US); Alfred ASTERJADHI, San Diego, CA (US); Yanjun SUN, San Diego, CA (US); Abdel Karim AJAMI, San Diego, CA (US)

(21) Appl. No.: 18/480,296

(22) Filed: Oct. 3, 2023

(51) Int. Cl. H04W 76/11

(52) U.S. Cl. CPC H04W 76/11

(57) ABSTRACT

This disclosure provides methods, components, devices, and systems for reconfiguration signaling for seamless roaming. Some aspects more specifically relate to reconfiguration signaling to facilitate link addition and link deletion operations for roaming, such as seamless roaming. Either a wireless station (STA) or an access point (AP) device may initiate the roaming. In some examples, a first device, such as the STA, a serving AP device, or a target AP device, may transmit a reconfiguration request to a second device, requesting to perform a link addition operation on links of the target AP device or to perform a link deletion operation on links of the serving AP device. The second device, which may be the STA, the serving AP device, or the target AP device, may transmit a reconfiguration response to indicate which links are to be deleted or added.

### TECHNICAL FIELD

This disclosure relates to wireless communication and, more specifically, to reconfiguration signaling for seamless roaming.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a STA may roam from one AP (such as a serving AP) to another AP (such as a target AP) based on various conditions, including (but not limited to) a location of the STA or a signal strength of the target AP. In some implementations, however, the STA may be unable to exchange data with the target AP until the STA obtains context information from the target AP, which may increase the latency associated with roaming operations.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a device. The method may include transmitting a request message to transition a wireless station from a first access point (AP) device to a second AP device in accordance with roaming of the wireless station, where the request message includes a first set of parameters for a link deletion operation associated with the first AP device, or a second set of parameters for a link addition operation associated with the second AP device, or both and receiving, in response to the request message, a response message including a first set of identifiers associated with the link deletion operation, or a second set of identifiers associated with the link addition operation, or both.

Another innovative aspect of the subject matter described in this disclosure can be implemented in a device for wireless communications. The device may include a processing system that includes processor circuitry and memory circuitry that stores code. The processing system may be configured to cause the device to transmit a request message to transition a wireless station from a first AP device to a second AP device in accordance with roaming of the wireless station, where the request message includes a first set of parameters for a link deletion operation associated with the first AP device, or a second set of parameters for a link addition operation associated with the second AP device, or both and receive, in response to the request message, a response message including a first set of identifiers associated with the link deletion operation, or a second set of identifiers associated with the link addition operation, or both.

Another innovative aspect of the subject matter described in this disclosure can be implemented in a device for wireless communications. The device may include means for transmitting a request message to transition a wireless station from a first AP device to a second AP device in accordance with roaming of the wireless station, where the request message includes a first set of parameters for a link deletion operation associated with the first AP device, or a second set of parameters for a link addition operation associated with the second AP device, or both and means for receiving, in response to the request message, a response message including a first set of identifiers associated with the link deletion operation, or a second set of identifiers associated with the link addition operation, or both.

Another innovative aspect of the subject matter described in this disclosure can be implemented in a non-transitory computer-readable medium storing code for wireless communications. The code may include instructions executable by a processor to transmit a request message to transition a wireless station from a first AP device to a second AP device in accordance with roaming of the wireless station, where the request message includes a first set of parameters for a link deletion operation associated with the first AP device, or a second set of parameters for a link addition operation associated with the second AP device, or both and receive, in response to the request message, a response message including a first set of identifiers associated with the link deletion operation, or a second set of identifiers associated with the link addition operation, or both.

Another innovative aspect of the subject matter described in this disclosure can be implemented in a method for wireless communications by a device. The method may include receiving a request message to transition a wireless station from a first AP device to a second AP device in accordance with roaming of the wireless station without reassociation, where the request message includes a first set of parameters for a link deletion operation associated with the first AP device, or a second set of parameters for a link addition operation associated with the second AP device, or both and transmitting, in response to the request message, a response message including a first set of identifiers associated with the link deletion operation, or a second set of identifiers associated with the link addition operation, or both.

Another innovative aspect of the subject matter described in this disclosure can be implemented in a device for wireless communications. The device may include a processing system that includes processor circuitry and memory circuitry that stores code. The processing system may be configured to cause the device to receive a request message to transition a wireless station from a first AP device to a second AP device in accordance with roaming of the wireless station without reassociation, where the request message includes a first set of parameters for a link deletion operation associated with the first AP device, or a second set of parameters for a link addition operation associated with the second AP device, or both and transmit, in response to the request message, a response message including a first set of identifiers associated with the link deletion operation, or a second set of identifiers associated with the link addition operation, or both.

Another innovative aspect of the subject matter described in this disclosure can be implemented in a device for wireless communications. The device may include means for receiving a request message to transition a wireless station from a first AP device to a second AP device in accordance with roaming of the wireless station without reassociation, where the request message includes a first set of parameters for a link deletion operation associated with the first AP device, or a second set of parameters for a link addition operation associated with the second AP device, or both and means for transmitting, in response to the request message, a response message including a first set of identifiers associated with the link deletion operation, or a second set of identifiers associated with the link addition operation, or both.

Another innovative aspect of the subject matter described in this disclosure can be implemented in a non-transitory computer-readable medium storing code for wireless communications. The code may include instructions executable by a processor to receive a request message to transition a wireless station from a first AP device to a second AP device in accordance with roaming of the wireless station without reassociation, where the request message includes a first set of parameters for a link deletion operation associated with the first AP device, or a second set of parameters for a link addition operation associated with the second AP device, or both and transmit, in response to the request message, a response message including a first set of identifiers associated with the link deletion operation, or a second set of identifiers associated with the link addition operation, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows a signaling diagram that supports reconfiguration signaling for seamless roaming.

FIG. 6 shows a process flow that supports reconfiguration signaling for seamless roaming.

FIG. 7 shows a block diagram of an example wireless communication device that supports reconfiguration signaling for seamless roaming.

FIG. 8 shows a block diagram of an example wireless communication device that supports reconfiguration signaling for seamless roaming.

FIGS. 9 and 10 show flowcharts illustrating example processes performable by or at a device that supports reconfiguration signaling for seamless roaming.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

A WLAN may include one or more access points (APs) and non-AP stations (STAs) that communicate with each other via specific communication links (such as channels within a given frequency band). In some WLANs that support multi-link operations (MLO), a non-AP STA may be affiliated with a non-AP multi-link device (MLD) that operates on multiple communication links. For example, a first STA of the non-AP MLD may operate on a first communication link (such as a 2.4 gigahertz (GHz) channel), while a second STA of the non-AP MLD may operate on a second communication link (such as a 6 GHz channel). Likewise, an AP may be affiliated with (such as controlled or managed by) one or more AP MLDs that operate on more than one communication link. As used herein, the term “STA” may refer to any type of wireless STA, such as a non-AP STA, a non-MLD STA, a non-MLD non-AP STA, or the like. Similarly, the term “AP” may refer to any type of wireless AP, such as an AP MLD or a non-MLD AP, among other examples.

In some implementations, a STA (such as a non-AP MLD or a non-MLD non-AP STA) may roam from a first AP (such as a serving AP) to a second AP (such as a target AP) based on various conditions, including (but not limited to) a location of the STA, a signal strength of the first AP, a signal strength of the second AP, and so on. To begin exchanging user data with the second AP, however, the STA may have to wait for the first AP to provide the second AP with various user data context parameters, such as an encryption key, a packet number (PN), a sequence number (SN), a block acknowledgement (BA), and a set of encryption keys for the STA, which can introduce latency and signaling overhead.

Various aspects relate generally to reconfiguration signaling for seamless roaming. Some aspects more specifically relate to signaling that is transmitted and received to initiate seamless roaming, such as reconfiguration request signaling to perform an add link operation on links of a target AP device and to perform a delete link operations on links of a serving AP device, as well as reconfiguration response signaling to indicate which links are to be deleted or added, or both. Either a STA or an AP device may initiate the roaming. For example, a STA affiliated with a non-AP MLD may transmit a request message to perform a link addition operation for one or more links of a target AP device or a link deletion operation for one or more links of a serving AP device, or both. The STA may transmit the request message to the serving AP device or the target AP device, or both. For example, the STA may transmit a reconfiguration request message to the target AP device indicating a link addition operation on one or more links of the target AP device and a link deletion operation on one or more links of a serving AP device. In some implementations, an AP device may initiate the roaming procedure. For example, a serving AP device may transmit a request message to a target AP device or the STA to initiate roaming of the STA to the target AP device. Additionally, or alternatively, the target AP device may transmit a request message to the serving AP device or the STA to initiate roaming of the STA to the target AP device.

Particular aspects of the subject matter described in this disclosure can be implemented to realize one or more of the following potential advantages. In some implementations, by transmitting or receiving signaling reconfiguration signaling, such as reconfiguration requests and reconfiguration responses, a STA may roam to a target AP by using a subset of user data context parameters associated with (such as assigned to) the target AP device. The techniques described indicate which links of a serving AP device to delete and which links of a target AP device to add to facilitate the roaming. Furthermore, the described techniques can be used for seamless roaming, whereby the STA transitions from a serving AP device to a target AP device without performing a reassociation frame exchange with the target AP device.

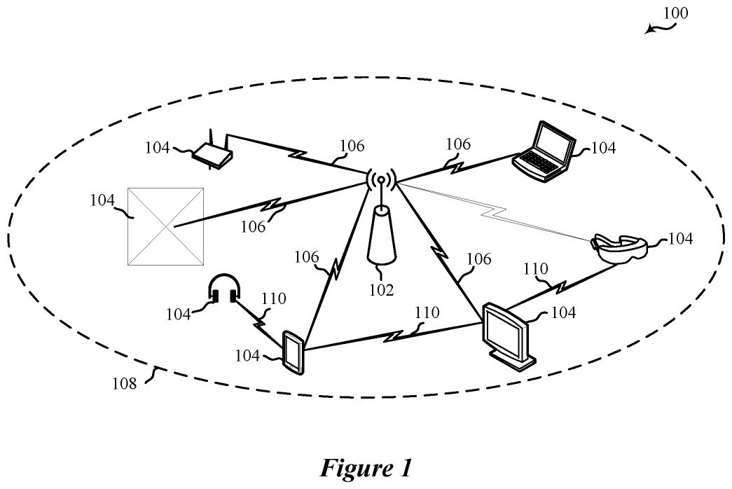

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless AP 102 and any number of STAs 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP MLD), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHZ, 5 GHZ, 6 GHz, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHZ), FR2 (24.25 GHZ-52.6 GHz), FR3 (7.125 GHZ-24.25 GHZ), FR4a or FR4-1 (52.6 GHZ-71 GHz), FR4 (52.6 GHZ-114.25 GHZ), and FR5 (114.25 GHZ-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHZ bands, each of which is divided into multiple 20 MHz channels. As such, these PPDUs are transmitted over a physical channel having a minimum bandwidth of 20 MHZ, but larger channels can be formed through channel bonding. For example, PPDUs may be transmitted over physical channels having bandwidths of 40 MHZ, 80 MHZ, 160 MHZ, 240 MHZ, 320 MHz, 480 MHz, or 640 MHz by bonding together multiple 20 MHz channels.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11 be and 802.11bn standard amendments) to provide additional capabilities over other previous systems (such as High Efficiency (HE) systems or other legacy systems). For example, the IEEE 802.11 be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHZ, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

In some implementations, devices, such as an AP 102, an AP device, or a STA 104, may transmit and receive reconfiguration signaling to facilitate roaming of the STA 104 to a target AP device. The reconfiguration signaling may include a reconfiguration request message to perform an add link operation on links of a target AP device and to perform a delete link operations on links of a serving AP device, as well as reconfiguration response message to indicate which links are to be deleted or added. Either a STA 104 or an AP device may initiate the roaming. For example, a STA 104 affiliated with a non-AP MLD may transmit a request message to perform a link addition operation for one or more links of a target AP device or a link deletion operation for one or more links of a serving AP device, or both. The STA 104 may transmit the request message to the serving AP device or the target AP device, or both. For example, the STA 104 may transmit a reconfiguration request message to the target AP device indicating a link addition operation on one or more links of the target AP device and a deletion operation on one or more links of a serving AP device. In some implementations, an AP device may initiate the roaming procedure. For example, a serving AP device may transmit a request message to a target AP device or the STA 104 to initiate roaming of the STA 104 to the target AP device. Additionally, or alternatively, the target AP device may transmit a request message to the serving AP device or the STA 104 to initiate roaming of the STA 104 to the target AP device.

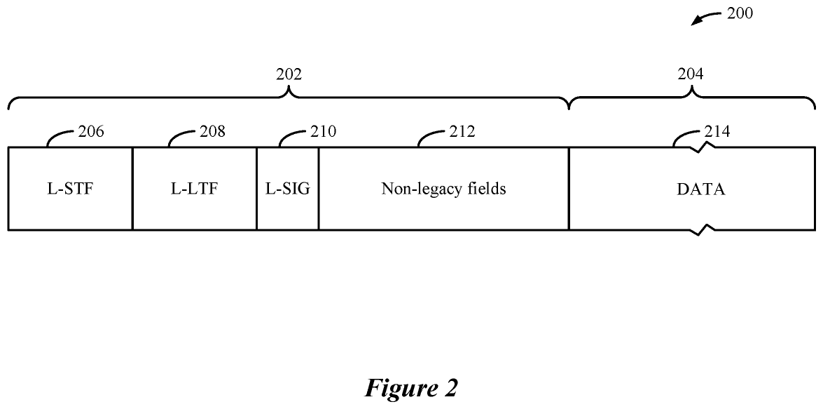

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some implementations, devices, such as an AP 102, an AP device, or a STA 104, may transmit and receive reconfiguration signaling to facilitate roaming of the STA 104 to a target AP device. The reconfiguration signaling may include a reconfiguration request message to perform an add link operation on links of a target AP device and to perform a delete link operations on links of a serving AP device, as well as reconfiguration response message to indicate which links are to be deleted or added. Either a STA 104 or an AP device may initiate the roaming. For example, a STA 104 affiliated with a non-AP MLD may transmit a request message to perform a link addition operation for one or more links of a target AP device or a link deletion operation for one or more links of a serving AP device, or both. The STA 104 may transmit the request message to the serving AP device or the target AP device, or both. For example, the STA 104 may transmit a reconfiguration request message to the target AP device indicating a link addition operation on one or more links of the target AP device and a deletion operation on one or more links of a serving AP device. In some implementations, an AP device may initiate the roaming procedure. For example, a serving AP device may transmit a request message to a target AP device or the STA 104 to initiate roaming of the STA 104 to the target AP device. Additionally, or alternatively, the target AP device may transmit a request message to the serving AP device or the STA 104 to initiate roaming of the STA 104 to the target AP device.

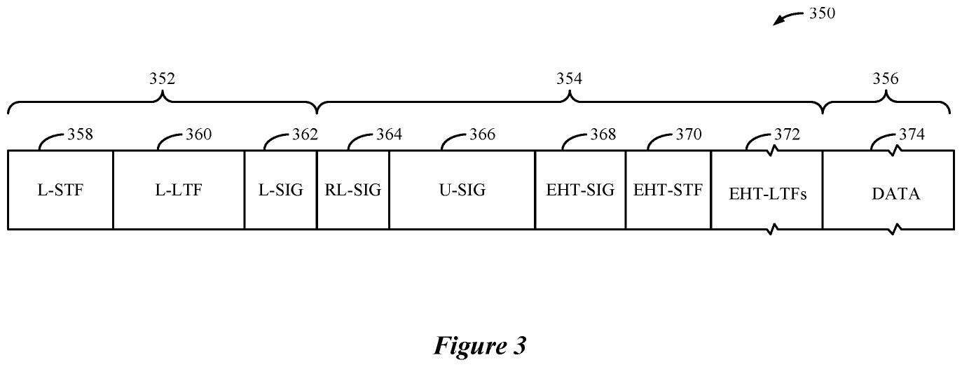

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as the AP 102 or the STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

The EHT-SIG 368 may be used by an AP 102 to identify and inform one or multiple STAs 104 that the AP 102 has scheduled uplink (UL) or downlink (DL) resources for them. The EHT-SIG 368 may be decoded by each compatible STA 104 served by the AP 102. The EHT-SIG 368 may generally be used by the receiving device to interpret bits in the data field 374. For example, the EHT-SIG 368 may include resource unit (RU) allocation information, spatial stream configuration information, and per-user (such as STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some implementations, devices, such as an AP 102, an AP device, or a STA 104, may transmit and receive reconfiguration signaling to facilitate roaming of the STA 104 to a target AP device. The reconfiguration signaling may include a reconfiguration request message to perform an add link operation on links of a target AP device and to perform a delete link operations on links of a serving AP device, as well as reconfiguration response message to indicate which links are to be deleted or added. Either a STA 104 or an AP device may initiate the roaming. For example, a STA 104 affiliated with a non-AP MLD may transmit a request message to perform a link addition operation for one or more links of a target AP device or a link deletion operation for one or more links of a serving AP device, or both. The STA 104 may transmit the request message to the serving AP device or the target AP device, or both. For example, the STA 104 may transmit a reconfiguration request message to the target AP device indicating a link addition operation on one or more links of the target AP device and a deletion operation on one or more links of a serving AP device. In some implementations, an AP device may initiate the roaming procedure. For example, a serving AP device may transmit a request message to a target AP device or the STA 104 to initiate roaming of the STA 104 to the target AP device. Additionally, or alternatively, the target AP device may transmit a request message to the serving AP device or the STA 104 to initiate roaming of the STA 104 to the target AP device.

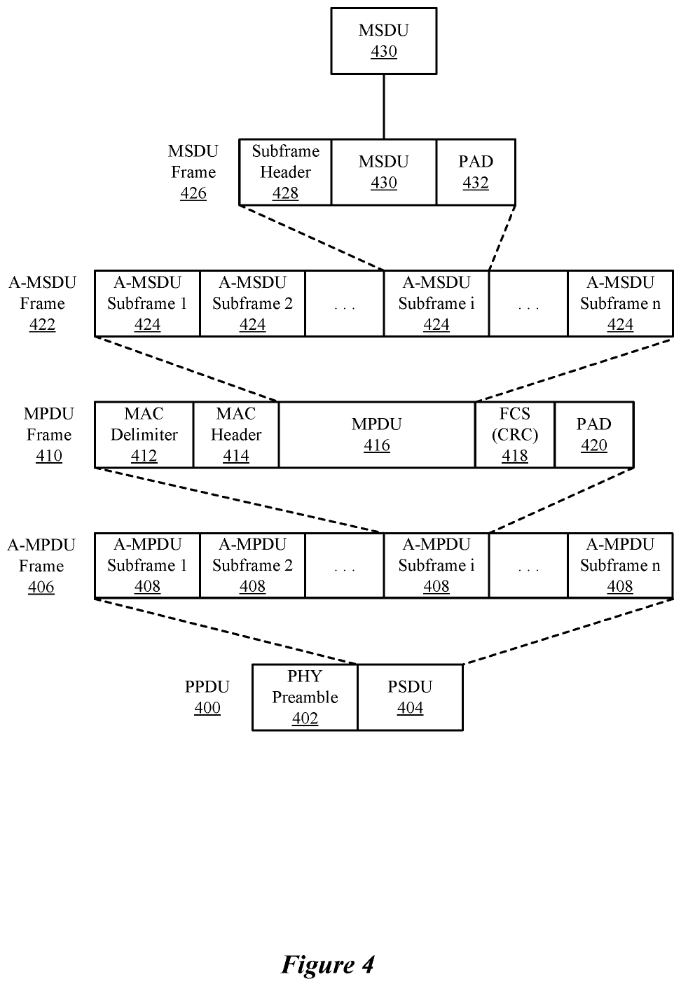

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field may include a cyclic redundancy check (CRC)) and padding bits 420. The MPDU 416 may carry one or more MAC service data units (MSDUs) 416. For example, the MPDU 416 may carry an aggregated MSDU (A-MSDU) 422 including multiple A-MSDU subframes 424. Each A-MSDU subframe 424 contains a corresponding MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body 416. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body 416. For example, the MAC header 414 may include a combination of a source address, a transmitter address, a receiver address, or a destination address. The MAC header 414 may further include a frame control field containing control information. The frame control field may specify a frame type, for example, a data frame, a control frame, or a management frame.

Some wireless communication devices (including both APs and STAs such as, for example, AP 102 and STAs 104 described with reference to FIG. 1) are capable of multi-link operation (MLO). In some examples, MLO supports establishing multiple different communication links (such as a first link on the 2.4 GHz band, a second link on the 5 GHz band, and the third link on the 6 GHz band) between the STA 104 and the AP 102 and exchanging packets on one or more communications links concurrently and dynamically. Each communication link may support one or more sets of channels or logical entities. In some examples, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as an MLD. An MLD may include a single upper MAC layer, and can include, for example, three independent lower MAC layers and three associated independent PHY layers for respective links in the 2.4 GHZ, 5 GHZ, and 6 GHz bands. This architecture may enable a single association process and security context. An AP MLD may include multiple APs each configured to communicate on a respective communication link with a respective one of multiple STAs 104 of a non-AP MLD (also referred to as a “STA MLD”). The STA MLD may communicate with the AP MLD over one or more of the multiple communication links at a given time. MLDs may independently contend for access on each of the communication links, which achieves latency reduction by enabling the MLD to transmit its packets on the first communication link that becomes available.

Another feature of MLO is Traffic Steering and QoS characterization, which achieves latency reduction and other QoS enhancements by mapping traffic flows having different latency or other requirements to different links. For example, traffic with low latency requirements can be mapped to wireless links operating in the 6 GHz band and more latency-tolerant flows can be mapped to wireless links operating in the 2.4 GHz or 5 GHz bands.

One type of MLO is alternating multi-link, in which a MLD may listen to two different high performance channels at the same time. When an MLD has traffic to send, it may use the first channel with an access opportunity (such as TXOP). While the MLD may only use one channel to receive or transmit at a time, having access opportunities in two different channels provides low latency when networks are congested.

Another type of MLO is multi-link aggregation (MLA), where traffic associated with a single STA 104 is simultaneously transmitted across multiple communication links in parallel to maximize the utilization of available resources to achieve higher throughput. This is akin to carrier aggregation in the cellular space. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

In some implementations, devices, such as an AP 102, an AP device, or a STA 104, may transmit and receive reconfiguration signaling to facilitate roaming of the STA 104 to a target AP device. The reconfiguration signaling may include a reconfiguration request message to perform an add link operation on links of a target AP device and to perform a delete link operations on links of a serving AP device, as well as reconfiguration response message to indicate which links are to be deleted or added. Either a STA 104 or an AP device may initiate the roaming. For example, a STA 104 affiliated with a non-AP MLD may transmit a request message to perform a link addition operation for one or more links of a target AP device or a link deletion operation for one or more links of a serving AP device, or both. The STA 104 may transmit the request message to the serving AP device or the target AP device, or both. For example, the STA 104 may transmit a reconfiguration request message to the target AP device indicating a link addition operation on one or more links of the target AP device and a deletion operation on one or more links of a serving AP device. In some implementations, an AP device may initiate the roaming procedure. For example, a serving AP device may transmit a request message to a target AP device or the STA 104 to initiate roaming of the STA 104 to the target AP device. Additionally, or alternatively, the target AP device may transmit a request message to the serving AP device or the STA 104 to initiate roaming of the STA 104 to the target AP device.

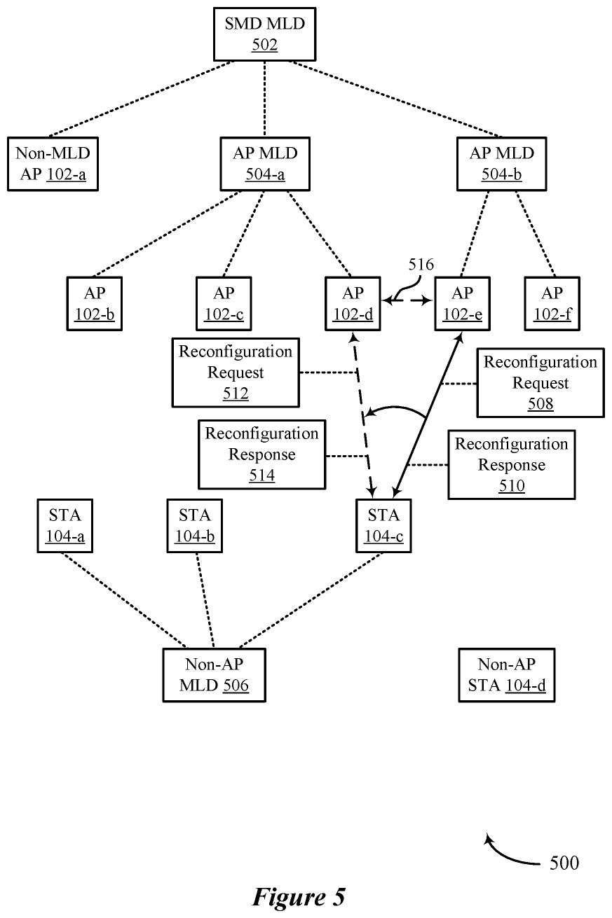

FIG. 5 shows a signaling diagram 500 that supports reconfiguration signaling for seamless roaming. The signaling diagram 500 may implement one or more aspects of the wireless communication network 100. For example, the signaling diagram 500 includes an AP 102-a (such as a non-MLD AP), and AP 102-b (such as an MLD AP), an AP 102-c, an AP 102-d, an AP 102-e, and an AP 102-f, which may be examples of aspects of an AP 102, as shown and described with reference to FIG. 1. Likewise, the signaling diagram 500 includes a STA 104-a (such as a non-AP MLD STA), a STA 104-b, a STA 104-c, and a STA 104-d (such as a non-MLD non-AP STA), which may be examples of a STA 104, as shown and described with reference to FIG. 1.

In some WLANs (such as the wireless communication network 100), when the signal strength of a serving AP (such as the AP 102-e) is weakening, a STA (such as the STA 104-c) may roam to a target AP (such as the AP 102-d) with a better signal quality without waiting for buffered/in-flight DL packets to arrive from the serving AP. Roaming may be useful for upper layer applications that are unaffected by packet loss during roaming, upper layer applications that can handle/process packets delivered out-of-order (between the serving and target APs) during roaming. Roaming also can be used for periodic extended reality (XR) traffic, which may have a data burst arrival every 16.66 ms. Following a traffic burst, the STA may not expect more traffic until the next burst, so the STA can utilize this gap to roam to a better AP without data interruptions.

As used herein, the term “AP” encompasses both non-MLD APs (such as APs that operate on a single communication link) and AP MLDs 504 that operate on more than one communication link. Likewise, the term “STA” encompasses both non-MLD non-AP STAs (such as STAs that operate on a single communication link) and non-AP MLD that operate on more than one communication link. Thus, in the following description of the signaling diagram 500, when referring to communications between a STA and an AP, the “STA” may be a non-MLD non-AP STA (such as a non-AP STA that is not affiliated with a non-AP MLD, such as the STA 104-d) or an non-AP MLD STA (such as the STA 104-c affiliated with the non-AP MLD 506), and the “AP” may be a non-MLD AP (such as the AP 102-a) or an MLD AP (such as the AP 102-d affiliated with the AP MLD 504-a or the AP 102-e affiliated with the AP MLD 504-b).

In some implementations, there may be a hierarchy between an SMD MLD 502 and AP devices, such as the non-MLD AP 102-a, the AP MLD 504-a, and the AP MLD 504-b. The SMD MLD 502 may have one or more affiliated AP devices, which may be examples of AP MLDs 504 or non-MLD APs 102. If an AP device is affiliated with an AP MLD 504, and the AP MLD 504 is affiliated with the SMD MLD 502, that AP device also may be affiliated with the SMD MLD 502.

Some wireless communications networks may support addition and removal of an affiliated AP device from a multi-link setup. In some examples, an AP MLD 504 may advertise addition or removal of an affiliated AP device via broadcast or global signaling. In some examples, an AP MLD 504 may be able to indicate or recommend an additional or removal of an affiliated AP device. In some systems, these addition and removal procedures may be performed with respect to links, not MLD, and may not be able to identify an AP MLD 504 or links affiliated with the AP MLD 504 that are being added or removed, or both. The signaling diagram may support techniques for addition and removal of an AP device, or links of the AP device, to facilitate roaming, including seamless roaming.

In some examples, an operation to add one or more links of a target AP device or to add the target AP device to be affiliated with a STA 104 may be referred to as an add operation, a link addition operation, or an addition operation. A reconfiguration request and a reconfiguration response may each include one or more fields indicating parameters associated with the link addition operation. An operation to remove one or more links of a serving AP device or to remove the serving AP device from being affiliated with a STA 104 may be referred to as a remove operation, a link removal operation, a link deletion operation, or a delete operation. A reconfiguration request and a reconfiguration response may each include one or more fields indicating parameters associated with the link deletion operation.

For example, a device in the signaling diagram 500, such as a STA 104 or an AP device (such as a non-MLD AP 102 or an AP MLD 504) may transmit and receive reconfiguration signaling for roaming of the STA 104 from a serving AP device to a target AP device. For example, a first device may transmit a request message or a reconfiguration request message to a second device. The reconfiguration request message may identify one or more links of the target AP device for performing a link addition operation, or the reconfiguration message may identify one or more links of the serving AP device for performing a link deletion operation, or both. The second device may transmit response message or a reconfiguration response message to the first device. The reconfiguration response message may identify links of the target AP device which were accepted for the link addition operation or links of the source AP device which were accepted for the link deletion operation, or both.

Either the STA 104 or a network device, such as an AP device or a non-AP MLD 506, may initiate the roaming. For example, the STA 104-c may initiate the roaming and transmit the reconfiguration request. In some implementations, a multi-link may be an example of the reconfiguration request. The reconfiguration request may include a reconfiguration element, such as a reconfiguration multi-link information element. In some implementations, the reconfiguration request may include a basic multi-link information element. In some other examples, the reconfiguration request may correspond to a dedicated frame, which may be associated with roaming, seamless roaming, or Ultra High Reliability (UHR) features.

The STA 104-c may transmit the reconfiguration request to either the serving AP device or the target AP device. A non-AP device, such as the STA 104-c or the non-AP MLD 506, may perform an add and remove operation in a same frame, where the target AP device is added for the STA 104-c and the current serving AP device is deleted for the STA 104-c. The In some other examples, the add and remove operation may be performed in sequence, such as the add operation occurring in a first frame and the delete operation occurring after the add operations (such as in a following frame or after a short time interval).

An AP device which receives the reconfiguration request may transmit a reconfiguration response, such as a link reconfiguration response frame. In some implementations, for the add operation, a basic multi-link information element carried in the reconfiguration response may indicate which links are accepted for addition based on the reconfiguration request. The reconfiguration response may include an identifier of the target AP device. For example, an MLD MAC address field in a common info field of the basic multi-link information element that indicates an AP MLD MAC address of the target AP device. In some implementations, for the delete operation, the reconfiguration response may indicate link identifiers of links that are accepted for deletion. For example, the reconfiguration response may indicate include a link identifier info field, which indicates link identifiers of the links that are accepted for the link deletion operation. When a link addition operation and a link deletion operation are performed simultaneously or in a same frame, some bits in a link identifier information field may indicate a type of operation (such as the link addition operation or the link deletion operation) to which a status field and a link identifier field apply to. For example, the reconfiguration response may indicate link identifiers of links that are accepted for the addition operation and an indication that the link identifiers of the link that are accepted for the addition operation are associated with the addition operation, and similar indications for the link deletion operation.

In some examples, a network device, such as a serving AP device or a target AP device, may initiate or request roaming of a STA 104 to the target AP device. When the serving AP device transmits the reconfiguration request, the reconfiguration request may identify the target AP device via an AP MLD identifier of the target AP device. The AP MLD identifier of the target AP device may be carried or indicated via a common info field or STA info field of the reconfiguration request. When the target AP device transmits the reconfiguration request, the reconfiguration request may identify the serving AP device via a MAC address, such as an AP MLD MAC address. For example, the reconfiguration request may carry or indicate the MAC address of the serving AP device via a common info field or a STA info field.

A device which receives the reconfiguration request from an AP device (such as the serving AP device or the target AP device) may transmit a reconfiguration response. The reconfiguration response may include parameters described herein, such as an indication of which links are accepted for the addition operation or which links are accepted for the deletion operation, or both. In some examples, a non-AP device, such as the STA 104 or a non-AP MLD 506, may receive the reconfiguration request from the AP device. Additionally, or alternatively, another AP device may receive the reconfiguration request from the AP device, such as a serving AP device transmitting the reconfiguration request to the target AP device.

In some examples, a reconfiguration request or a reconfiguration response may include multiple per-STA profiles. If the reconfiguration request or the reconfiguration response includes multiple, complete per-STA profiles, a size of the message may be very large. In some implementations, the reconfiguration request message or the reconfiguration response message, or both, may implement an inheritance mechanism to reduce the size of the messages. For example, a reconfiguration request message may include, as a first per-STA profile, a per-STA profile which has the highest quantity of common elements or common fields with other profiles that are being reported in a same message. Subsequent per-STA profiles may apply inheritance with respect to the first per-STA profile. For example, if the first per-STA profile has multiple fields that are shared with other per-STA profiles, the first per-STA profile may include the fields and values for the fields, and the other per-STA profiles (such as per-STA profiles with similar fields or values for the fields) may not include those fields, which may reduce a size of the reconfiguration request message. Similar techniques may be applied for the reconfiguration response message.

In some implementations, the fields of the reconfiguration request message may be based on which device is transmitting or receiving the reconfiguration request message. For example, the signaling may occur between a STA 104 and a serving AP device. For example, the STA 104-c may transmit a reconfiguration request 508 to the AP device 105-e, or the AP device 105-e may transmit a reconfiguration request 508 to the STA 104-e. The reconfiguration request message may include a field associated with an add operation or a field associated with a delete operation, or both. An add operation field in a reconfiguration request message between the STA 104 and the serving AP device may include information to identify the target AP device or links of the target AP device, or both. For example, the STA info field of a per-STA profile sub-element of an add operation field may include an identifier of the target AP device. For example, the add operation field may include an AP MLD identifier of the target AP device. In some examples, the reconfiguration request may include a presence indicator bit in the STA control field to indicate if the add operation field is present. In some examples, the add operation field may include a value or identifier that the serving AP device has assigned to the target AP device or target AP MLD. In some examples, a controller may assign identifiers or AP MLD identifiers to each AP device, so that the AP MLD identifiers are consistent across AP devices. If one per-STA profile sub-element is present in the add operation field, the add operation field may request to add each link of the target AP device, or target AP MLD. In some examples, each link of the target AP device may be requested to be added based on the link identifier field indicating a specific value. If one or more per-STA profile sub-elements are included in the add operation field, the non-AP MLD may be requesting addition of specific links of the target AP device or target AP MLD. The specific links may be identified by corresponding link identifier fields, which may be assigned by the target AP device or target AP MLD. Each per-STA profile sub-element of the reconfiguration request may include a complete profile for the affiliated non-AP STA that is operating on one of the requested links.

Additionally, or alternatively, a common info field of the reconfiguration request transmitted between a STA 104 and a serving AP device may include a field that indicates an identifier of the AP MLD or target AP MLD. The field may have a corresponding presence indicator bit in the STA control field to indicate whether the field is present. The field may include an integer value that the serving AP device has assigned to the target AP MLD. In some examples, if a per-STA profile sub-element is absent, the non-AP MLD may be requesting to add all links of the target AP device or target AP MLD. If the per-STA profile sub-element is missing, a basic multi-link information element may be carried in the frame and include a complete profile for each STA of the non-AP MLD 506 operating on all of the links. If one or more per-STA profile sub-elements are present, the non-AP MLD may be requesting addition of specific links of the target AP MLD, which may be identified by a link identifier field, and each per-STA profile sub-element may include a complete profile for the affiliated non-AP STA that is operating on the requested link.

For a delete operation of a reconfiguration request that is signaled between a STA 104 and a serving AP device, a delete operation field may include information corresponding to the serving AP device. In some examples, each STA info field of the delete operation field may indicate a link to be deleted or removed. In some examples, a field in the common info field, or carried in a single STA info field, may indicate a delete operation of all links, or removal of the AP MLD as the serving AP device. In some examples, a value in the reconfiguration type field may indicate a request to delete links by including per-STA profiles.

When a reconfiguration request signaled between a STA 104 and a serving AP device is requesting a link addition procedure and a link deletion procedure in a same frame, the reconfiguration request may include per-STA profiles of the target AP device and associated requested links for addition and per-STA profiles to indicate deletion of links from the serving AP device. In some examples, a common info field may indicate deletion of all links of the serving AP device (such as serving AP MLD) or addition of all links of a target AP device (such as target AP MLD), or both. In some examples, the reconfiguration request may include both link info and common info fields. For example, the reconfiguration request may include a commo info field indicating to delete all links of a serving AP device and per-STA profiles which indicate to add specific links of the target AP device. Alternatively, the reconfiguration message may include a per-STA profile to indicate to delete a subset of links of the serving AP device and a common info field indicating to add all links of the target AP device. In some examples, a frame may include two reconfiguration request messages, where a first reconfiguration request includes an add operation field, and a second reconfiguration request includes a delete operation field.

In some implementations, a STA 104 may transmit a reconfiguration request message to a target AP device, or the target AP device may transmit a reconfiguration request message to the STA 104. For example, the STA 104-c may transmit a reconfiguration request 512 to the AP device 102-d, or the AP device 102-d may transmit a reconfiguration request 512 to the STA 104-c. A delete operation field in a reconfiguration request message between the STA 104 and the target AP device may include information to identify the serving AP device or links of the serving AP device, or both. For example, the STA info field of a per-STA profile sub-element of a delete operation field may include an identifier of the serving AP device. For example, the delete operation field may include a MAC address of the serving AP device. In some implementations, the delete operation field may include an AP MLD identifier of the serving AP device, such as if the AP MLD identifiers are assigned globally or by a network controller (such as so that the AP MLD identifiers are consistent across AP devices). In some examples, the reconfiguration request may include a presence indicator bit in the STA control field to indicate if the delete operation field is present. If one per-STA profile sub-element is present in the delete operation field, the delete operation field may request to delete all links of the serving AP device, or serving AP MLD. In some examples, each link of the target AP device may be requested to be deleted based on the link identifier field indicating a specific value. If one or more per-STA profile sub-elements are included in the delete operation field, the non-AP MLD may be requesting deletion of specific links of the serving AP device or serving AP MLD.

Additionally, or alternatively, a common info field of the reconfiguration request transmitted between a STA 104 and a target AP device may include a field that indicates an identifier of the AP MLD or serving AP MLD. For example, the common info field may indicate a MAC address of the serving AP device, such as an AP MLD MAC address of the serving AP device. The field may have a corresponding presence indicator bit in the STA control field to indicate whether the field is present. In some implementations, if a per-STA profile sub-element is missing, the non-AP MLD may be requesting to remove all links of the target AP device or target AP MLD. In some implementations, if a per-STA profile sub-element is missing, the non-AP MLD may be requesting to keep the links of the serving AP MLD, such as when a non-AP MLD 506 is configured to be served by one or more AP MLDs 504. In some implementations, if a per-STA profile sub-element is missing, a subfield in the common info field may indicate whether the non-AP MLD is requesting to delete all links or keep all links of the serving AP MLD. If one or more per-STA profile sub-elements are present, the non-AP MLD may be requesting to remove specific links of the serving AP MLD.

For an add operation of a reconfiguration request that is signaled between a STA 104 and a target AP device, an add operation field may include information corresponding to the target AP device. In some examples, the add operation field may indicate to add all or a subset of links of the target AP device.

When a reconfiguration request signaled between a STA 104 and a target AP device is requesting a link addition procedure and a link deletion procedure in a same frame, the reconfiguration request may include per-STA profiles of the target AP device and associated requested links for addition and per-STA profiles to indicate deletion of links from the serving AP device. In some examples, a frame may include two reconfiguration request messages, where a first reconfiguration request includes an add operation field, and a second reconfiguration request includes a delete operation field.

If a STA 104 or a non-AP MLD 506 transmits the reconfiguration request to an AP device 102, such as a serving AP device or a target AP device, the AP device 102 may transmit back a reconfiguration response. For example, the AP device 102-e may transmit a reconfiguration response 510 in response to the reconfiguration request 508, and the AP device 102-d may transmit a reconfiguration response 514 in response to the reconfiguration request 512. Additionally, or alternatively, if an AP device transmits the reconfiguration request to the STA 104 or non-AP MLD 506, the STA 104 or non-AP MLD 506 may transmit the reconfiguration response.

In some implementations, a reconfiguration response may include a basic multi-link information element. The basic multi-link information element may include information of the target AP device and request links. For an add operation, a link identifier field may indicate links that are accepted for addition based on the request. For an add operation, a MAC address field, such as an MLD MAC address field, in the common info field of the basic multi-link information element may carry a MAC address, such as an MLD MAC address, of the target AP device. For a delete operation, the link identifier field may indicate link identifiers of links that are accepted for deletion. In some examples, all link requested for deletion may be deleted from the STA 104 or non-AP MLD 506. When add requests and remove requests are sent in a same frame, one or more bits in a link identifier info field may indicate a type of operation (such as an add operation or a delete operation) for which the status and link identifier fields apply to.

In some implementations, a serving AP device may transmit the reconfiguration request to a target AP device. For example, the AP device 102-e may transmit the reconfiguration request to the AP device 102-d via a communication link 516. The AP device 102-d may transmit a reconfiguration response to the AP device 102-e in response to the reconfiguration request. In some implementations, a target AP device may transmit the reconfiguration request to a serving AP device. For example, the AP device 102-d may transmit the reconfiguration request to the AP device 102-e via a communication link 516. The AP device 102-e may transmit a reconfiguration response to the AP device 102-d in response to the reconfiguration request.

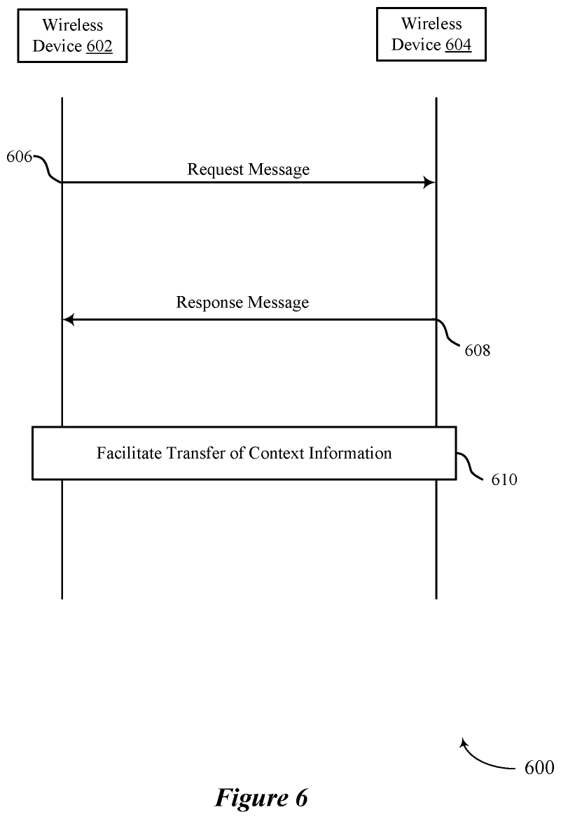

FIG. 6 shows an example of a process flow 600 that supports reconfiguration signaling for seamless roaming. The process flow 600 may implement one or more aspects of the wireless communication network 100 or the signaling diagram 500, as shown and described with reference to FIGS. 1 and 5. For example, the process flow 600 includes a wireless device 602 and a wireless device 604 which may communicate with each other via one or more communication links 106. The wireless device 602 and the wireless device 604 may each be an example of a non-AP device, such as a STA 104 or a non-AP MLD 506, or an AP device, such as a non-MLD AP 102 or an MLD AP 504.

At 606, the wireless device 602 may transmit a request message to the wireless device 604. For example, the wireless device 602 may transmit a request message (such as a reconfiguration request or a reconfiguration request frame) to transition a STA from a first AP device to a second AP device in accordance with roaming of the STA without reassociation. The request message may include a first set of parameters for a link deletion operation associated with the first AP device, or a second set of parameters for a link addition operation associated with the second AP device, or both.

In some examples, the wireless device 602 may be the STA. For example, the wireless device 602 may transmit the request message to the first AP device, the serving AP device, or the second AP device, the target AP device. In some implementations, if the STA transmits the request message to the serving AP device, the second set of parameters may include one or more per-STA profiles for each of one or more links between the STA and the second AP device, or target AP device. In some implementations, if the STA transmits the request message to the target AP device, the second set of parameters may include one or more per-STA profiles for each of one or more links between the STA and the first AP device, or serving AP device.

Additionally, or alternatively, the wireless device 602 may be an AP device. For example, the wireless device 602 may be the first AP device, or the serving AP device, and the serving AP device may transmit the request message to the STA. Additionally, or alternatively, the wireless device 602 may be the second AP device, or the target AP device, and the target AP device may transmit the request message to the STA. In some examples, the first AP device may transmit the request message to the second AP device. For example, the serving AP device may transmit a reconfiguration request to a target AP device, or a target AP device may transmit a reconfiguration request to a serving AP device.

In some implementations, the first set of parameters for the link deletion operation includes one or more identifiers of the first set of identifiers, an MLD AP identifier associated with the first AP device, an identifier associated with the first AP device, an indicator to delete all links to the first AP device, or any combination thereof. In some implementations, the second set of parameters for the link addition operation includes one or more identifiers of the second set of identifiers, an MLD AP identifier associated with the second AP device, an identifier associated with the second AP device, an indicator to add all links of the second AP device, or any combination thereof.

At 608, the wireless device 604 may transmit a response message to the wireless device 602. For example, the wireless device 604 may transmit, in response to the request message, a response message including a first set of identifier associated with the link deletion operation, or a second set of identifiers associated with the link addition operation, or both.

In some implementations, the wireless device 602 may be the STA, and the wireless device 602 may receive the response message from the target AP device or the serving AP device. In some implementations, the wireless device 602 may be the serving AP device or the target AP device, and the wireless device 602 may receive the response message from the STA. In some implementations, the wireless device 602 may be the serving AP device, and the wireless device 602 may receive the response message from the target AP device, or the wireless device 602 may be the target AP device, and the wireless device 602 may receive the response message from the serving AP device.

At 610, the wireless device 602 or the wireless device 604, or both, may facilitate a transfer of context information for the STA from the first AP device to the second AP device in accordance with the roaming. In some examples, facilitating the transfer of context information for the STA may include transferring the STA from being served by the first AP devices to the second AP device. For example, the second AP device may acquire, such as from the first AP device, a non-AP MLD, or an SMD MLD, the context information or parameters to perform wireless communications with the STA.

For seamless roaming, the first AP device, or the serving AP device, may indicate at least a portion of context information associated with a non-AP MLD or wireless device to one or more candidate AP devices. In some examples, the serving AP device may indicate the context information to the one or more candidate AP devices via a backhaul link, such as a wired ethernet link or a wireless backhaul link, or via over-the-air signaling, such as AP-to-AP communications. If the serving AP device indicates the context information via a backhaul link, the serving AP device may send the context information through multiple devices, such network switches or controllers. In some implementations, the context information may include one or more encryption keys associated with the STA, one or more pseudorandom numbers associated with the STA, one or more sequence numbers associated with the STA, one or more block acknowledgments associated with the STA, or any combination thereof. In some implementations, the wireless device 602 may be the STA and may roam, from the first AP device to the second AP device, without performing a reassociation procedure with the second AP device based on the response message.

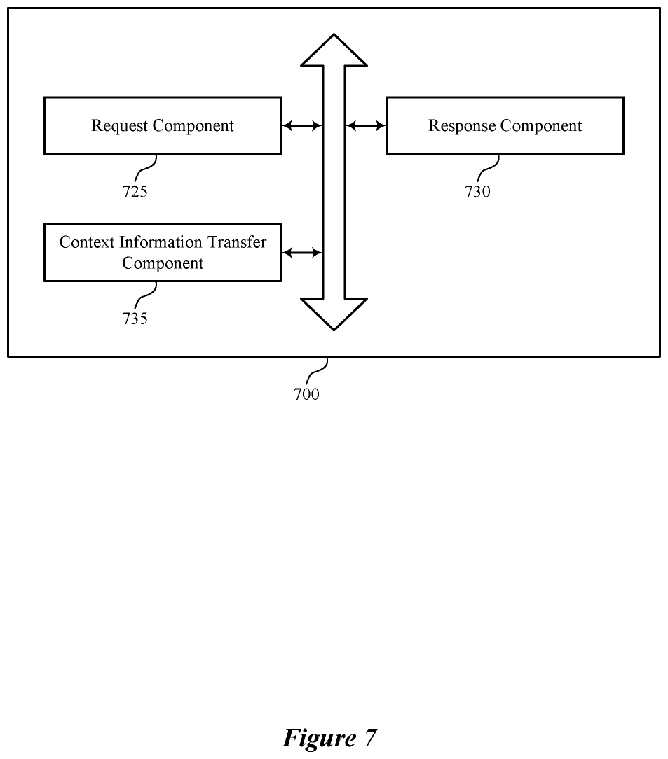

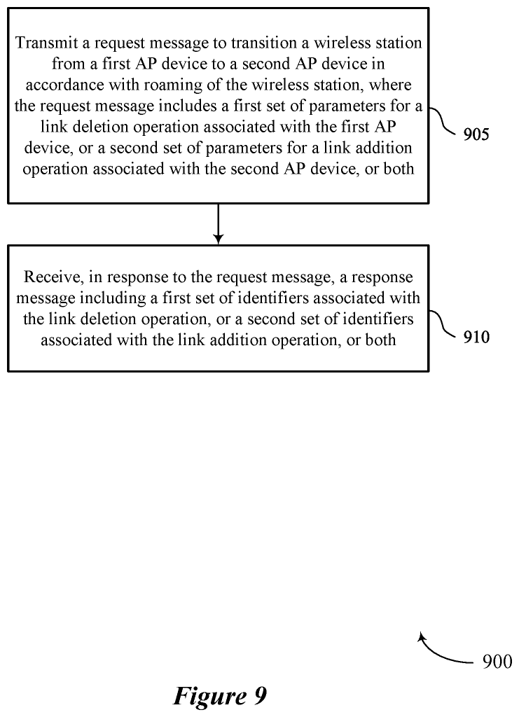

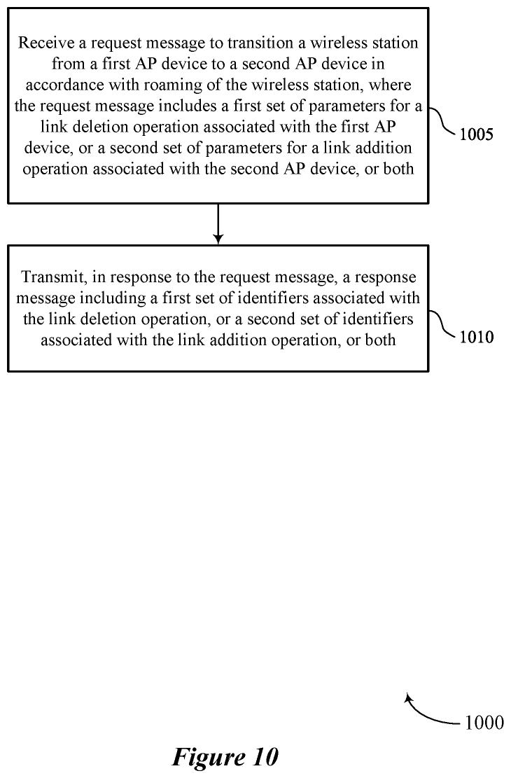

FIG. 7 shows a block diagram of an example wireless communication device 700 that supports reconfiguration signaling for seamless roaming. In some examples, the wireless communication device 700 is configured to perform the processes 900 and 1000 described with reference to FIGS. 9 and 10, respectively. The wireless communication device 700 may include one or more chips, SoCs, chipsets, packages, components, or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry.”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can configurable or configured for use in an AP, such as the AP 102 described with reference to FIG. 1. In some other examples, the wireless communication device 700 can be an AP that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes at least one external network interface coupled with the processing system that enables communication with a core network or backhaul network that enables the wireless communication device 700 to gain access to external networks including the Internet.

The wireless communication device 700 includes a request component 725, a response component 730, and a context information transfer component 735. Portions of one or more of the request component 725, the response component 730, and the context information transfer component 735 may be implemented at least in part in hardware or firmware. For example, one or more of the request component 725, the response component 730, and the context information transfer component 735 may be implemented at least in part by at least a processor or a modem. In some examples, portions of one or more of the request component 725, the response component 730, and the context information transfer component 735 may be implemented at least in part by a processor and software in the form of processor-executable code stored in memory.

The wireless communication device 700 may support wireless communications in accordance with examples as disclosed herein. The request component 725 is configurable or configured to transmit a request message to transition a wireless station from a first AP device to a second AP device in accordance with roaming of the wireless station, where the request message includes a first set of parameters for a link deletion operation associated with the first AP device, or a second set of parameters for a link addition operation associated with the second AP device, or both. The response component 730 is configurable or configured to receive, in response to the request message, a response message including a first set of identifiers associated with the link deletion operation, or a second set of identifiers associated with the link addition operation, or both.

In some examples, to support transmitting the request message, the request component 725 is configurable or configured to transmit the request message to the first AP device, where the device is the wireless station, and where the first AP device is associated with the link deletion operation.

In some examples, the second set of parameters for the link addition operation include one or more per-station profiles for each of one or more links between the wireless station and the second AP device.

In some examples, to support transmitting the request message, the request component 725 is configurable or configured to transmit the request message to the second AP device, where the device is the wireless station, and where the second AP device is associated with the link addition operation.

In some examples, the first set of parameters for the link deletion operation include one or more per-station profiles for each of one or more links between the wireless station and the first AP device.

In some examples, the response message includes a MAC address of the second AP device.

In some examples, the response message is a first response message, and the response component 730 is configurable or configured to receive a second response message including the second set of identifiers associated with the link addition operation, where the first response message includes the first set of identifiers associated with the link deletion operation.

In some examples, the response message includes the first set of identifiers and the second set of identifiers.

In some examples, the response component 730 is configurable or configured to roam, from the first AP device to the second AP device, without performing a reassociation procedure with the second AP device based on the response message, where the device is the wireless station.

In some examples, to support transmitting the request message, the request component 725 is configurable or configured to transmit the request message to the second AP device, where the device is the first AP device.

In some examples, the request message includes an MLD AP identifier of the second AP device.

In some examples, to support transmitting the request message, the request component 725 is configurable or configured to transmit the request message to the first AP device, where the device is the second AP device.

In some examples, the request message includes an MLD MAC address of the first AP device, or an MLD AP identifier of the first AP device, or both.

In some examples, the first set of parameters includes a set of multiple profiles for a respective set of multiple links from the first AP device. In some examples, a portion of information of a first profile of the set of multiple profiles is inherited by each other profile of the set of multiple profiles.

In some examples, each identifier of the first set of identifiers and the second set of identifiers correspond to an AP MLD, a non-MLD AP, or both.

In some examples, the response component 730 is configurable or configured to facilitate a transfer of context information for the wireless station from the first AP device to the second AP device in accordance with the roaming.

In some examples, the first set of parameters for the link deletion operation includes one or more identifiers of the first set of identifiers, an MLD AP identifier associated with the first AP device, an identifier associated with the first AP device, an indicator to delete all links to the first AP device, or any combination thereof.

In some examples, the second set of parameters for the link addition operation includes one or more identifiers of the second set of identifiers, an MLD AP identifier associated with the second AP device, an identifier associated with the second AP device, an indicator to add all links of the second AP device, or any combination thereof.

Additionally, or alternatively, the wireless communication device 700 may support wireless communications in accordance with examples as disclosed herein. In some examples, the request component 725 is configurable or configured to receive a request message to transition a wireless station from a first AP device to a second AP device in accordance with roaming of the wireless station, where the request message includes a first set of parameters for a link deletion operation associated with the first AP device, or a second set of parameters for a link addition operation associated with the second AP device, or both. In some examples, the response component 730 is configurable or configured to transmit, in response to the request message, a response message including a first set of identifiers associated with the link deletion operation, or a second set of identifiers associated with the link addition operation, or both. The context information transfer component 735 is configurable or configured to facilitate a transfer of context information for the wireless station from the first AP device to the second AP device in accordance with the roaming.

In some examples, to support receiving the request message, the request component 725 is configurable or configured to receive the request message from the wireless station, where the device is the first AP device.

In some examples, the second set of parameters for the link addition operation includes one or more per-station profiles for each of one or more links between the wireless station and the second AP device.

In some examples, to support receiving the request message, the request component 725 is configurable or configured to receive the request message from the wireless station, where the device is the second AP device.

In some examples, the first set of parameters for the link deletion operation includes one or more per-station profiles for each of one or more links between the wireless station and the first AP device.

In some examples, the response message is a first response message, and the response component 730 is configurable or configured to transmit a second response message including the second set of identifiers associated with the link addition operation, where the first response message includes the first set of identifiers associated with the link deletion operation.

In some examples, to support receiving the request message, the request component 725 is configurable or configured to receive the request message from the first AP device, where the device is the wireless station.

In some examples, to support receiving the request message, the request component 725 is configurable or configured to receive the request message from the second AP device, where the device is the wireless station.

In some examples, the request message includes an MLD MAC address of the first AP device, or an MLD AP identifier of the first AP device, or both.

In some examples, the first set of parameters for the link deletion operation includes one or more identifiers of the first set of identifiers, an MLD AP identifier associated with the first AP device, an identifier associated with the first AP device, an indicator to delete all links to the first AP device, or any combination thereof, and the second set of parameters for the link addition operation includes one or more identifiers of the second set of identifiers, an MLD AP identifier associated with the second AP device, an identifier associated with the second AP device, an indicator to add all links of the second AP device, or any combination thereof.

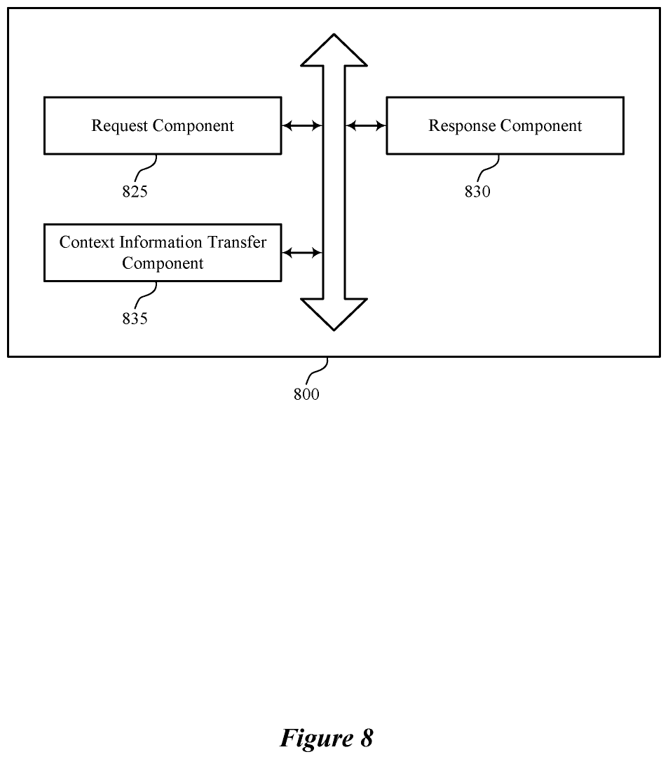

FIG. 8 shows a block diagram of an example wireless communication device 800 that supports reconfiguration signaling for seamless roaming. In some examples, the wireless communication device 800 is configured to perform the processes 900 and 1000 described with reference to FIGS. 9 and 10, respectively. The wireless communication device 800 may include one or more chips, SoCs, chipsets, packages, components, or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is then passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 800 can configurable or configured for use in a STA, such as the STA 104 described with reference to FIG. 1. In some other examples, the wireless communication device 800 can be a STA that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other examples, the wireless communication device 800 can be configurable or configured to transmit and receive signals and communications conforming to one or more 3GPP specifications including those for 5G NR or 6G. In some examples, the wireless communication device 800 also includes or can be coupled with one or more application processors which may be further coupled with one or more other memories. In some examples, the wireless communication device 800 further includes a user interface (UI) (such as a touchscreen or keypad) and a display, which may be integrated with the UI to form a touchscreen display that is coupled with the processing system. In some examples, the wireless communication device 800 may further include one or more sensors such as, for example, one or more inertial sensors, accelerometers, temperature sensors, pressure sensors, or altitude sensors, that are coupled with the processing system.

The wireless communication device 800 includes a request component 825, a response component 830, and a context information transfer component 835. Portions of one or more of the request component 825, the response component 830, and the context information transfer component 835 may be implemented at least in part in hardware or firmware. For example, one or more of the request component 825, the response component 830, and the context information transfer component 835 may be implemented at least in part by at least a processor or a modem. In some examples, portions of one or more of the request component 825, the response component 830, and the context information transfer component 835 may be implemented at least in part by a processor and software in the form of processor-executable code stored in memory.

The wireless communication device 800 may support wireless communications in accordance with examples as disclosed herein. The request component 825 is configurable or configured to transmit a request message to transition a wireless station from a first AP device to a second AP device in accordance with roaming of the wireless station, where the request message includes a first set of parameters for a link deletion operation associated with the first AP device, or a second set of parameters for a link addition operation associated with the second AP device, or both. The response component 830 is configurable or configured to receive, in response to the request message, a response message including a first set of identifiers associated with the link deletion operation, or a second set of identifiers associated with the link addition operation, or both.

In some examples, to support transmitting the request message, the request component 825 is configurable or configured to transmit the request message to the first AP device, where the device is the wireless station.

In some examples, the second set of parameters for the link addition operation includes one or more per-station profiles for each of one or more links between the wireless station and the second AP device.

In some examples, to support transmitting the request message, the request component 825 is configurable or configured to transmit the request message to the second AP device, where the device is the wireless station.

In some examples, the first set of parameters for the link deletion operation includes one or more per-station profiles for each of one or more links between the wireless station and the first AP device.

In some examples, the response message includes a Media Access Control address of the second AP device.

In some examples, the response message is a first response message, and the response component 830 is configurable or configured to receive a second response message including the second set of identifiers associated with the link addition operation, where the first response message includes the first set of identifiers associated with the link deletion operation.

In some examples, the response message includes the first set of identifiers and the second set of identifiers.

In some examples, the response component 830 is configurable or configured to roam, from the first AP device to the second AP device, without performing a reassociation procedure with the second AP device based on the response message, where the device is the wireless station.

In some examples, to support transmitting the request message, the request component 825 is configurable or configured to transmit the request message to the second AP device, where the device is the wireless station.

In some examples, the request message includes an MLD AP identifier of the second AP device.

In some examples, to support transmitting the request message, the request component 825 is configurable or configured to transmit the request message to the first AP device, where the device is the wireless station.

In some examples, the request message includes an MLD MAC address of the first AP device, or an MLD AP identifier of the first AP device, or both.

In some examples, the first set of parameters includes a set of multiple profiles for a respective set of multiple links from the first AP device. In some examples, a portion of information of a first profile of the set of multiple profiles is inherited by each other profile of the set of multiple profiles.

In some examples, each identifier of the first set of identifiers and the second set of identifiers correspond to an AP MLD, a non-MLD AP, or both.

In some examples, the response component 830 is configurable or configured to facilitate a transfer of context information for the wireless station from the first AP device to the second AP device in accordance with the roaming.

In some examples, the first set of parameters for the link deletion operation includes one or more identifiers of the first set of identifiers, an MLD AP identifier associated with the first AP device, an identifier associated with the first AP device, an indicator to delete all links to the first AP device, or any combination thereof.

In some examples, the second set of parameters for the link addition operation includes one or more identifiers of the second set of identifiers, an MLD AP identifier associated with the second AP device, an identifier associated with the second AP device, an indicator to add all links of the second AP device, or any combination thereof.

Additionally, or alternatively, the wireless communication device 800 may support wireless communications in accordance with examples as disclosed herein. In some examples, the request component 825 is configurable or configured to receive a request message to transition a wireless station from a first AP device to a second AP device in accordance with roaming of the wireless station, where the request message includes a first set of parameters for a link deletion operation associated with the first AP device, or a second set of parameters for a link addition operation associated with the second AP device, or both. In some examples, the response component 830 is configurable or configured to transmit, in response to the request message, a response message including a first set of identifiers associated with the link deletion operation, or a second set of identifiers associated with the link addition operation, or both. The context information transfer component 835 is configurable or configured to facilitate a transfer of context information for the wireless station from the first AP device to the second AP device in accordance with the roaming.

In some examples, to support receiving the request message, the request component 825 is configurable or configured to receive the request message from the wireless station, where the device is the first AP device.

In some examples, the second set of parameters for the link addition operation includes one or more per-station profiles for each of one or more links between the wireless station and the second AP device.

In some examples, to support receiving the request message, the request component 825 is configurable or configured to receive the request message from the wireless station, where the device is the second AP device.

In some examples, the first set of parameters for the link deletion operation includes one or more per-station profiles for each of one or more links between the wireless station and the first AP device.

In some examples, the response message is a first response message, and the response component 830 is configurable or configured to transmit a second response message including the second set of identifiers associated with the link addition operation, where the first response message includes the first set of identifiers associated with the link deletion operation.

In some examples, to support receiving the request message, the request component 825 is configurable or configured to receive the request message from the first AP device, where the device is the wireless station.

In some examples, to support receiving the request message, the request component 825 is configurable or configured to receive the request message from the second AP device, where the device is the wireless station.

In some examples, the request message includes an MLD MAC address of the first AP device, or an MLD AP identifier of the first AP device, or both.

In some examples, the first set of parameters for the link deletion operation includes one or more identifiers of the first set of identifiers, an MLD AP identifier associated with the first AP device, an identifier associated with the first AP device, an indicator to delete all links to the first AP device, or any combination thereof, and the second set of parameters for the link addition operation includes one or more identifiers of the second set of identifiers, an MLD AP identifier associated with the second AP device, an identifier associated with the second AP device, an indicator to add all links of the second AP device, or any combination thereof.

FIG. 9 shows a flowchart illustrating an example process 900 performable by or at a device that supports reconfiguration signaling for seamless roaming. The operations of the process 900 may be implemented by a device or its components as described herein. For example, the process 900 may be performed by a wireless communication device, such as the wireless communication device 700 described with reference to FIG. 7, operating as or within a wireless AP or a wireless STA. In some examples, the process 900 may be performed by a wireless AP or a wireless STA, such as one of the APs 102 or the STAs 104 described with reference to FIG. 1.

In some examples, in block 905, the device may transmit a request message to transition a wireless station from a first AP device to a second AP device in accordance with roaming of the wireless station, where the request message includes a first set of parameters for a link deletion operation associated with the first AP device, or a second set of parameters for a link addition operation associated with the second AP device, or both. The operations of block 905 may be performed in accordance with examples as disclosed herein. In some implementations, aspects of the operations of block 905 may be performed by a request component 725 or a request component 825 as described with reference to FIGS. 7 and 8.

In some examples, in block 910, the device may receive, in response to the request message, a response message including a first set of identifiers associated with the link deletion operation, or a second set of identifiers associated with the link addition operation, or both. The operations of block 910 may be performed in accordance with examples as disclosed herein. In some implementations, aspects of the operations of block 910 may be performed by a response component 730 or a response component 830 as described with reference to FIGS. 7 and 8.

FIG. 10 shows a flowchart illustrating an example process 1000 performable by or at a device that supports reconfiguration signaling for seamless roaming. The operations of the process 1000 may be implemented by a device or its components as described herein. For example, the process 1000 may be performed by a wireless communication device, such as the wireless communication device 700 described with reference to FIG. 7, operating as or within a wireless AP or a wireless STA. In some examples, the process 1000 may be performed by a wireless AP or a wireless STA, such as one of the APs 102 or the STAs 104 described with reference to FIG. 1.

In some examples, in block 1005, the device may receive a request message to transition a wireless station from a first AP device to a second AP device in accordance with roaming of the wireless station, where the request message includes a first set of parameters for a link deletion operation associated with the first AP device, or a second set of parameters for a link addition operation associated with the second AP device, or both. The operations of block 1005 may be performed in accordance with examples as disclosed herein. In some implementations, aspects of the operations of block 1005 may be performed by a request component 725 or a request component 825 as described with reference to FIGS. 7 and 8.

In some examples, in block 1010, the device may transmit, in response to the request message, a response message including a first set of identifiers associated with the link deletion operation, or a second set of identifiers associated with the link addition operation, or both. The operations of block 1010 may be performed in accordance with examples as disclosed herein. In some implementations, aspects of the operations of block 1010 may be performed by a response component 730 or a response component 830 as described with reference to FIGS. 7 and 8.

Implementation examples are described in the following numbered clauses:

The following provides an overview of aspects of the present disclosure:

Aspect 1: A method for wireless communications at a device, including: transmitting a request message to transition a wireless station from a first AP device to a second AP device in accordance with roaming of the wireless station, where the request message includes a first set of parameters for a link deletion operation associated with the first AP device, or a second set of parameters for a link addition operation associated with the second AP device, or both; and receiving, in response to the request message, a response message including a first set of identifiers associated with the link deletion operation, or a second set of identifiers associated with the link addition operation, or both.

Aspect 2: The method of aspect 1, where transmitting the request message includes: transmitting the request message to the first AP device, where the device is the wireless station, and where the first AP device is associated with the link deletion operation.

Aspect 3: The method of aspect 2, where the second set of parameters for the link addition operation includes one or more per-station profiles for each of one or more links between the wireless station and the second AP device.

Aspect 4: The method of any of aspects 1 through 3, where transmitting the request message includes: transmitting the request message to the second AP device, where the device is the wireless station, and where the second AP device is associated with the link addition operation.

Aspect 5: The method of aspect 4, where the first set of parameters for the link deletion operation includes one or more per-station profiles for each of one or more links between the wireless station and the first AP device.

Aspect 6: The method of any of aspects 1 through 5, where the response message includes a Media Access Control address of the second AP device.

Aspect 7: The method of any of aspects 1 through 6, where the response message is a first response message, the method further including: receiving a second response message including the second set of identifiers associated with the link addition operation, where the first response message includes the first set of identifiers associated with the link deletion operation.

Aspect 8: The method of any of aspects 1 through 7, where the response message includes the first set of identifiers and the second set of identifiers.

Aspect 9: The method of any of aspects 1 through 8, further including: roaming, from the first AP device to the second AP device, without performing a reassociation procedure with the second AP device based at least in part on the response message, where the device is the wireless station.

Aspect 10: The method of any of aspects 1 through 9, where transmitting the request message includes: transmitting the request message to the second AP device, where the device is the wireless station.

Aspect 11: The method of aspect 10, where the request message includes an MLD AP identifier of the second AP device.

Aspect 12: The method of any of aspects 1 through 11, where transmitting the request message includes: transmitting the request message to the first AP device, where the device is the wireless station.

Aspect 13: The method of aspect 12, where the request message includes an MLD MAC address of the first AP device, or an MLD AP identifier of the first AP device, or both.

Aspect 14: The method of any of aspects 1 through 13, where the first set of parameters includes a set of multiple profiles for a respective set of multiple links from the first AP device, a portion of information of a first profile of the set of multiple profiles is inherited by each other profile of the set of multiple profiles.

Aspect 15: The method of any of aspects 1 through 14, where each identifier of the first set of identifiers and the second set of identifiers corresponds to an AP MLD, a non-MLD AP, or both.

Aspect 16: The method of any of aspects 1 through 15, further including: facilitating a transfer of context information for the wireless station from the first AP device to the second AP device in accordance with the roaming, where the context information for the wireless station includes one or more encryption keys associated with the wireless station, one or more pseudorandom numbers associated with the wireless station, one or more sequence numbers associated with the wireless station, one or more block acknowledgments associated with the wireless station, or any combination thereof.

Aspect 17: The method of any of aspects 1 through 16, where the first set of parameters for the link deletion operation includes one or more identifiers of the first set of identifiers, an MLD AP identifier associated with the first AP device, an identifier associated with the first AP device, an indicator to delete all links to the first AP device, or any combination thereof.

Aspect 18: The method of any of aspects 1 through 17, where the second set of parameters for the link addition operation includes one or more identifiers of the second set of identifiers, an MLD AP identifier associated with the second AP device, an identifier associated with the second AP device, an indicator to add all links of the second AP device, or any combination thereof.

Aspect 19: A method for wireless communications at a device, including: receiving a request message to transition a wireless station from a first AP device to a second AP device in accordance with roaming of the wireless station without reassociation, where the request message includes a first set of parameters for a link deletion operation associated with the first AP device, or a second set of parameters for a link addition operation associated with the second AP device, or both; and transmitting, in response to the request message, a response message including a first set of identifiers associated with the link deletion operation, or a second set of identifiers associated with the link addition operation, or both.

Aspect 20: The method of aspect 19, where receiving the request message includes: receiving the request message from the wireless station, where the device is the first AP device, and where the first AP device is associated with the link deletion operation.

Aspect 21: The method of aspect 20, where the second set of parameters for the link addition operation includes one or more per-station profiles for each of one or more links between the wireless station and the second AP device.

Aspect 22: The method of any of aspects 19 through 21, where receiving the request message includes: receiving the request message from the wireless station, where the device is the second AP device, and where the second AP device is associated with the link addition operation.

Aspect 23: The method of aspect 22, where the first set of parameters for the link deletion operation includes one or more per-station profiles for each of one or more links between the wireless station and the first AP device.

Aspect 24: The method of any of aspects 19 through 23, where the response message is a first response message, the method further including: transmitting a second response message including the second set of identifiers associated with the link addition operation, where the first response message includes the first set of identifiers associated with the link deletion operation.

Aspect 25: The method of any of aspects 19 through 24, where receiving the request message includes: receiving the request message from the first AP device, where the device is the wireless station.

Aspect 26: The method of any of aspects 19 through 25, where receiving the request message includes: receiving the request message from the second AP device, where the device is the wireless station.

Aspect 27: The method of aspect 26, where the request message includes an MLD MAC address of the first AP device, or an MLD AP identifier of the first AP device, or both.

Aspect 28: The method of any of aspects 19 through 27, where the first set of parameters for the link deletion operation includes one or more identifiers of the first set of identifiers, an MLD AP identifier associated with the first AP device, an identifier associated with the first AP device, an indicator to delete all links to the first AP device, or any combination thereof, and the second set of parameters for the link addition operation includes one or more identifiers of the second set of identifiers, an MLD AP identifier associated with the second AP device, an identifier associated with the second AP device, an indicator to add all links of the second AP device, or any combination thereof.

Aspect 29: The method of any of aspects 19 through 28, further including: facilitating a transfer of context information for the wireless station from the first AP device to the second AP device in accordance with the roaming, where the context information includes one or more encryption keys associated with the wireless station, one or more pseudorandom numbers associated with the wireless station, one or more sequence numbers associated with the wireless station, one or more block acknowledgments associated with the wireless station, or any combination thereof.

Aspect 30: A device for wireless communications, including a processing system that includes processor circuitry and memory circuitry that stores code, the processing system configured to cause the device to perform a method of any of aspects 1 through 18.

Aspect 31: A device for wireless communications, including at least one means for performing a method of any of aspects 1 through 18.

Aspect 32: A non-transitory computer-readable medium storing code for wireless communications, the code including instructions executable by one or more processors to perform a method of any of aspects 1 through 18.

Aspect 33: A device for wireless communications, including a processing system that includes processor circuitry and memory circuitry that stores code, the processing system configured to cause the device to perform a method of any of aspects 19 through 29.

Aspect 34: A device for wireless communications, including at least one means for performing a method of any of aspects 19 through 29.

Aspect 35: A non-transitory computer-readable medium storing code for wireless communications, the code including instructions executable by one or more processors to perform a method of any of aspects 19 through 29.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A device, comprising:
a processing system that includes processor circuitry and memory circuitry that stores code, the processing system configured to cause the device to:
transmit a request message to transition a wireless station from a first access point (AP) device to a second AP device in accordance with roaming of the wireless station, wherein the request message comprises a first set of parameters for a link deletion operation associated with the first AP device, or a second set of parameters for a link addition operation associated with the second AP device, or both; and
receive, in response to the request message, a response message comprising a first set of identifiers associated with the link deletion operation, or a second set of identifiers associated with the link addition operation, or both.

2. The device of claim 1, wherein, to transmit the request message, the processing system is configured to cause the device to:
transmit the request message to the first AP device, wherein the device is the wireless station, and wherein the first AP device is associated with the link deletion operation.

3. The device of claim 2, wherein the second set of parameters for the link addition operation comprises one or more per-station profiles for each of one or more links between the wireless station and the second AP device.

4. The device of claim 1, wherein, to transmit the request message, the processing system is configured to cause the device to:
transmit the request message to the second AP device, wherein the device is the wireless station, and wherein the second AP device is associated with the link addition operation.

5. The device of claim 4, wherein the first set of parameters for the link deletion operation comprises one or more per-station profiles for each of one or more links between the wireless station and the first AP device.

6. The device of claim 1, wherein the response message comprises a Media Access Control address of the second AP device.

7. The device of claim 1, wherein the response message is a first response message, and the processing system is further configured to cause the device to:
receive a second response message comprising the second set of identifiers associated with the link addition operation, wherein the first response message comprises the first set of identifiers associated with the link deletion operation.

8. The device of claim 1, wherein the response message comprises the first set of identifiers and the second set of identifiers.

9. The device of claim 1, wherein the processing system is further configured to cause the device to:
roam, from the first AP device to the second AP device, without performing a reassociation procedure with the second AP device based at least in part on the response message, wherein the device is the wireless station.

10. The device of claim 1, wherein, to transmit the request message, the processing system is configured to cause the device to:
transmit the request message to the wireless station, wherein the device is the first AP device.

11. The device of claim 10, wherein the request message comprises a multi-link device (MLD) AP identifier of the second AP device.

12. The device of claim 1, wherein, to transmit the request message, the processing system is configured to cause the device to:
transmit the request message to the wireless station, wherein the device is the second AP device.

13. The device of claim 12, wherein the request message comprises a multi-link device (MLD) Media Access Control (MAC) address of the first AP device, or an MLD AP identifier of the first AP device, or both.

14. The device of claim 1, wherein the first set of parameters comprises a plurality of profiles for a respective plurality of links from the first AP device, and a portion of information of a first profile of the plurality of profiles is inherited by each other profile of the plurality of profiles.

15. The device of claim 1, wherein each identifier of the first set of identifiers and the second set of identifiers corresponds to an AP multi-link device (MLD), a non-MLD AP, or both.

16. The device of claim 1, wherein the processing system is further configured to cause the device to:
facilitate a transfer of context information for the wireless station from the first AP device to the second AP device in accordance with the roaming, wherein the context information for the wireless station comprises one or more encryption keys associated with the wireless station, one or more pseudorandom numbers associated with the wireless station, one or more sequence numbers associated with the wireless station, one or more block acknowledgments associated with the wireless station, or any combination thereof.

17. A device, comprising:
a processing system that includes processor circuitry and memory circuitry that stores code, the processing system configured to cause the device to:
receive a request message to transition a wireless station from a first access point (AP) device to a second AP device in accordance with roaming of the wireless station, wherein the request message comprises a first set of parameters for a link deletion operation associated with the first AP device, or a second set of parameters for a link addition operation associated with the second AP device, or both; and
transmit, in response to the request message, a response message comprising a first set of identifiers associated with the link deletion operation, or a second set of identifiers associated with the link addition operation, or both.

18. The device of claim 17, wherein, to receive the request message, the processing system is configured to cause the device to:
receive the request message from the wireless station, wherein the device is the first AP device, and wherein the first AP device is associated with the link deletion operation.

19. The device of claim 18, wherein the second set of parameters for the link addition operation comprises one or more per-station profiles for each of one or more links between the wireless station and the second AP device.

20. The device of claim 17, wherein, to receive the request message, the processing system is configured to cause the device to:
receive the request message from the wireless station, wherein the device is the second AP device, and wherein the second AP device is associated with the link addition operation.

21. The device of claim 20, wherein the first set of parameters for the link deletion operation comprises one or more per-station profiles for each of one or more links between the wireless station and the first AP device.

22. The device of claim 17, wherein the response message is a first response message, and the processing system is further configured to cause the device to:
transmit a second response message comprising the second set of identifiers associated with the link addition operation, wherein the first response message comprises the first set of identifiers associated with the link deletion operation.

23. The device of claim 17, wherein, to receive the request message, the processing system is configured to cause the device to:
receive the request message from the first AP device, wherein the device is the wireless station.

24. The device of claim 17, wherein the first set of parameters for the link deletion operation comprises one or more identifiers of the first set of identifiers, a multi-link device (MLD) AP identifier associated with the first AP device, an identifier associated with the first AP device, an indicator to delete all links to the first AP device, or any combination thereof, and the second set of parameters for the link addition operation comprises one or more identifiers of the second set of identifiers, a multi-link device (MLD) AP identifier associated with the second AP device, an identifier associated with the second AP device, an indicator to add all links of the second AP device, or any combination thereof.

25. The device of claim 17, wherein, the processing system is configured to cause the device to:
facilitate a transfer of context information for the wireless station from the first AP device to the second AP device in accordance with the roaming, wherein the context information comprises one or more encryption keys associated with the wireless station, one or more pseudorandom numbers associated with the wireless station, one or more sequence numbers associated with the wireless station, one or more block acknowledgments associated with the wireless station, or any combination thereof.

26. A method for wireless communications at a device, comprising:
transmitting a request message to transition a wireless station from a first access point (AP) device to a second AP device in accordance with roaming of the wireless station, wherein the request message comprises a first set of parameters for a link deletion operation associated with the first AP device, or a second set of parameters for a link addition operation associated with the second AP device, or both; and
receiving, in response to the request message, a response message comprising a first set of identifiers associated with the link deletion operation, or a second set of identifiers associated with the link addition operation, or both.

27. The method of claim 26, wherein transmitting the request message comprises:
transmitting the request message to the wireless station, wherein the device is the first AP device.

28. A method for wireless communications at a device, comprising:
receiving a request message to transition a wireless station from a first access point (AP) device to a second AP device in accordance with roaming of the wireless station, wherein the request message comprises a first set of parameters for a link deletion operation associated with the first AP device, or a second set of parameters for a link addition operation associated with the second AP device, or both; and
transmitting, in response to the request message, a response message comprising a first set of identifiers associated with the link deletion operation, or a second set of identifiers associated with the link addition operation, or both.

29. The method of claim 28, wherein receiving the request message comprises:
receiving the request message from the wireless station, wherein the device is the second AP device.

30. The method of claim 28, wherein the response message is a first response message, the method further comprising:
transmitting a second response message comprising the second set of identifiers associated with the link addition operation, wherein the first response message comprises the first set of identifiers associated with the link deletion operation.
